(19) United States
(12) Patent Application Publication
(10) Pub. No.: US 2025/0137878 A1
(43) Pub. Date: May 1, 2025

(54) MEASURING ASSEMBLY FOR DETECTING A DISTANCE BETWEEN TWO ELEMENTS, DISTANCE MEASURING DEVICE, OPTICAL MEASURING SYSTEM AND METHOD

(71) Applicant: Carl Zeiss SMT GmbH, Oberkochen (DE)

(72) Inventor: Jochen HETZLER, Aalen (DE)

(21) Appl. No.: 19/000,922

(22) Filed: Dec. 24, 2024

Related U.S. Application Data
(63) Continuation of application No. PCT/EP2023/069965, filed on Jul. 18, 2023.

(30) Foreign Application Priority Data
Jul. 19, 2022 (DE) 10 2022 207 358.4

(51) Int. Cl. G01M 11/08

(52) U.S. Cl. CPC G01M 11/081

(57) ABSTRACT

A measuring assembly for determining at least one distance between a first and a second optical element (2, 3). The first element is translucent as a measuring matrix and has a semi-reflective first surface (7). The second optical element is an EUV mirror and has an at least semi-reflective second surface (8). The first surface lies opposite the second surface at the distance to be detected. A light beam (14) generated by a light beam source (13) is coupled into the first optical element by a surface (11) that is different from the first surface. A first partial light beam (19) is reflected by the first surface and a second partial light beam (16) passing through the first surface is reflected by the second surface and each back into the first optical element. A light beam sensor (21) is arranged to detect both partial light beams, to determine the distance.

### CROSS-REFERENCE TO RELATED APPLICATION

This is a Continuation of International Application PCT/EP2023/069965, which has an international filing date of Jul. 18, 2023, and the disclosure of which is incorporated in its entirety into the present Continuation by reference. This Continuation also claims foreign priority under 35 U.S.C. § 119 (a)-(d) to and also incorporates by reference, in its entirety, German Patent Application DE 10 2022 207 358.4, filed Jul. 19, 2022.

### FIELD

The invention relates to a measurement arrangement for capturing at least one distance between a first and a second optical element, wherein the first element is embodied in the form of a light-transmissive measurement matrix and has a partially reflective first surface, wherein the second optical element is embodied in the form of an EUV mirror and has an at least partially reflective second surface, and wherein the first surface is opposite the second surface at the distance to be captured.

Furthermore, the invention relates to a distance measurement apparatus and to an optical measurement apparatus which have at least one measurement arrangement as described above.

Furthermore, the invention relates to a method for determining the above-explained distance between the abovementioned two elements.

### BACKGROUND

In optical systems or devices in which one or more light beams are directed and/or manipulated by a plurality of optical elements, it is important for the distance between these elements to lie within predetermined tolerances. In particular in the case of devices for measuring surface shapes with an optical matrix, as described in the hitherto unpublished patent application DE 10 2021 202 909.4 by the applicant, the distance between the optical elements must be precisely maintained. This is firstly in order not to falsify the measurement result, and secondly in order to avoid a collision of the optical elements with one another.

Measurement apparatuses for contactlessly capturing distances are known from the prior art. The prior art, includes a variety of laser measurement equipment which can determine a distance. However, the distance this equipment can capture is generally the distance between the laser measurement equipment itself and the object to be tested. In order to use such a laser measurement apparatus in an optical device, such as for example in a piece of matrix measurement equipment, the construction of the device would have to be completely altered, since the laser measurement equipment itself requires a large amount of installation space. In other known solutions, use is made of a laser measurement apparatus, with which the thickness and/or the distance of the elements from one another is capturable by reflection at optical elements. A corresponding solution is offered, for example, by Opto-Alignment Technology, Inc. under the name “Fogale Nanotech Lenscan system.” With this system, however, an in-situ measurement is not possible because the measurement equipment for carrying out the measurement has to be arranged in the operating beam path of the optical elements.

### SUMMARY

Accordingly, one object of the invention is to provide a measurement arrangement which is designed to save installation space. A further, related object is to reliably determine the distance of two elements from one another in situ.

These and other objects are achieved by a measurement arrangement having the features as claimed and/or as described herein. Such an arrangement has an advantage that, with only one light beam source and only one light beam sensor, the distance to be captured can be reliably determined with only one measurement process. Moreover, the light beam source and the light beam sensor can be integrated in a space-saving manner into, for example, one measurement system having the two elements mentioned above. This makes it possible, for example, to measure the distance during operation of the measurement device itself, that is to say in an in-situ distance ascertainment.

According to one formulation of the invention, this is achieved in that the measurement arrangement has a light beam source and a light beam sensor, wherein a light beam generated or generable by the light beam source is directed by the lens to couple into the first optical element through a surface different from the first surface and is focused at the first surface onto a focus point, such that a first partial light beam is reflected by the first surface and a second partial light beam traveling through the first surface is reflected by the second surface back into the first optical element in each case. The light beam sensor is arranged to capture both partial light beams in order to capture the distance depending on the captured partial light beams. In particular, the light beam source and light beam sensor are arranged fixedly in relation to the first element. As a result of the advantageous measurement arrangement, the light beam from the light beam source is thus reflected both at the first and at the second surface and in each case guided back through the first element to the light beam sensor. As a result, the light beam source and the light beam sensor can both be arranged on the side of the first optical element facing away from the second optical element and in particular also outside an operating beam path.

As a result, it becomes possible to integrate the elements into one measurement device without impairing the operation of the measurement device such that a determination of the distance is also possible during ongoing operation of the measurement device having the elements. By virtue of the fact that the light beam passes through the first surface and is likewise reflected at the second surface, the one light beam is divided into at least two partial light beams, the beam paths of which differ from one another by the distance between the surfaces. This is because the distance between the reflection points at the first and the second surface means that the back-reflected partial light beams are laterally spaced apart from one another. This displacement of the partial light beams in the reflected section relative to one another thus corresponds to the distance between the two elements. This displacement is captured by the light beam sensor and evaluated in order to determine the distance. An in-situ measurement is thus made possible with a simple and space-saving arrangement, with which the distance between the elements is precisely ascertained. The first optical element is a measurement matrix, in particular as described in the aforementioned earlier patent application DE 10 2021 202909.4 by the applicant. The first element is thus light-transmissive and partially reflective on the first surface, such that a part of the light beam passes further to the second surface in order to be reflected there. Here, the first surface is embodied such that the back-reflected partial light beam from the second surface is coupled into the first element again and is guided through the first element to the light beam sensor. Preferably, the curvature of the surface of the first optical element or of the measurement matrix and the curvature of the surface of the second optical element or of the EUV mirror are embodied inversely with respect to one another, such that the surfaces run parallel to one another. Furthermore, the second optical element is an EUV mirror (EUV=extreme ultraviolet radiation). Due to the advantageous embodiment of the measurement arrangement, the EUV mirror can be measured with and without a highly reflective coating.

In accordance with a preferred development of the invention, the measurement arrangement has a first focusing device with at least one first lens element and/or at least one mirror, which focusing device is arranged between the light beam source and the first element and is embodied to focus the light beam at the first surface onto a first focus point. As a result, the measurement quality is optimized or the measurement accuracy with respect to the captured distance is increased. In particular, this ensures that the light beam does not scatter before reaching the first surface and as a result leads to partial light beams which are reflected back to the light beam sensor and which could falsify the measurement result. The focusing ensures that all partial light beams emanate from the one focus point on the first surface and thus permit precise distance determination.

Particularly preferably, the light beam source and the first focusing device, in particular the lens element, are arranged and embodied such that the focused light beam is incident on the first surface at an angle deviating from 90° (with respect to the first surface).

Provision is furthermore preferably made for the light beam source and the light beam sensor to be arranged on a side of the first element facing away from the second element. This ensures that the light beam is reliably reflected at both surfaces and guided through the first optical element to the light beam sensor. Furthermore, an advantageous integration into an existing measurement system is thereby possible.

In accordance with a preferred embodiment of the invention, the light beam source and the first focusing device, in particular the lens element of the first focusing device, are arranged and embodied such that the light beam from the light beam source is coupled into the first optical element at the input-coupling point through the surface obliquely, in particular at an angle deviating from 90°, with respect to the surface.

The angle, with respect to the surface, at which the light beam is coupled into the first optical element through the surface is preferably smaller than 75°, preferably smaller than 45° and particularly preferably smaller than 30°.

Preferably, the light beam source is arranged laterally next to a (virtual) axis aligned perpendicularly with respect to the surface. In this case, the axis can be an axis of symmetry of the first optical element. This makes it possible for the measurement arrangement to be able to be integrated into an existing measurement system without influencing the optical unit of the measurement system. Here, the light beam source lies opposite the test object, in particular opposite the surface or laterally next to the surface, or it lies laterally next to the test object. In this context, it is preferred for the light beam sensor to likewise be arranged laterally of, in particular laterally next to, the axis aligned perpendicularly with respect to the surface, wherein the light beam source and the light beam sensor are preferably arranged on opposite sides of the (virtual) axis, that is to say are separated by the (virtual) axis.

In this context, provision is made in particular for the angle between the light beam source and the axis to be smaller than 120°, preferably smaller than 90° and particularly preferably smaller than 459.

Furthermore, it is preferred for the light beam source to be arranged, in particular to be arranged laterally so that the beam emitted by the light beam source is incident on the surface at an angle, wherein the angle α is smaller than 75°, preferably smaller than 45° and particularly preferably smaller than 30°.

The one first lens element of the first focusing device and/or of the second focusing device is preferably embodied to correct or compensate for the effects of the refraction of the light beam at the surface through which the light beam is coupled into the first element. In particular, the lens element has a shape which is configured for this purpose. For this purpose, the lens element is preferably embodied to be non-rotationally symmetric and, for this purpose, deviates in particular from a rotationally symmetric lens element by more than 1 μm. Alternatively or additionally, the lens element is preferably tilted for correction or compensation purposes about an axis aligned in particular perpendicular to the chief ray direction of the light beam. Optionally, the lens element is formed from a plurality of lens elements and/or mirrors, wherein at least one lens element deviates from the rotational symmetry by more than 1 μm.

According to a preferred development of the invention, at least one second focusing device with at least one second lens element and/or with at least one mirror is arranged between the first element and the light beam sensor, with which second focusing device the reflected partial light beams are directed onto the light beam sensor. Using the second focusing device, in particular with the second lens element, reliable capturing of the partial light beams by the light beam sensor is thus ensured. Optionally, the first and/or the second lens element are each assigned at least one further optical element, in particular a further lens element or a mirror, of the respective focusing device, with which the light beam and/or the partial light beams are deflected, with the result that a flexible arrangement of the light beam source and/or of the light beam sensor with respect to the optical elements is made possible.

Preferably, the second lens element, or the lens element of the second focusing device, is embodied and arranged to focus the partial light beams onto the light beam sensor such that each partial light beam has a focus point that is capturable by the light beam sensor. In particular, the light beam sensor is embodied to capture the position of the focus points of the partial light beams in order to determine the distance of the focus points from one another depending on the captured positions. Since the distance of the focus points corresponds to the distance of the elements relative to one another, an advantageous determination of the distance between the elements is thus ensured. The respective distance is determinable particularly precisely due to the formation of the focus points of the partial light beams. The light beam sensor is preferably embodied in the form of a camera sensor or a line scanner in order to capture the focus points of the partial light beams. The preferred focusing both onto the first surface or the gap region and onto the light beam sensor ensures a precise determination of the distance. In addition, tilting of the first and/or of the second optical element therefore does not result in an incorrect distance signal.

In accordance with a preferred embodiment of the invention, the light beam sensor has a planar sensor surface, wherein the at least one second lens element is embodied and arranged to focus the partial light beams onto the sensor surface. As a result, the focus points of the partial light beams lie on the sensor surface and are captured with great accuracy. The smaller the focus point is, the more accurately the position of the respective partial light beam on the sensor surface is determined. In particular, the light beam sensor or a controller of the measurement arrangement is designed to determine the distance of the elements in relation to one another depending on the position of the focus points of the partial light beams on the sensor surface. In this case, use is made of the fact that, with a changing distance, the position of the focus points of the partial light beams on the sensor surface also shifts. There is thus a direct geometric link between the distance to be captured and the position of the focus points on the sensor surface, which is utilized for determining the distance.

In a preferred embodiment, the light beam source and the first lens element, or the lens element of the first focusing device, are arranged such that the generated light beam is coupled into the first element through a surface of the first element lying opposite the first surface. Here, the refractive index at the further surface is taken into account by the configuration of the first lens element, such that the focus point of the light beam lies on the first surface. The first lens element is thus embodied depending on the refractive index, the angle of incidence of the light beam on the further surface, and the geometry of the first element.

In accordance with an alternative embodiment, the light beam source and the first lens element are arranged so that the generated light beam is coupled into the first element through a further surface of the first element arranged laterally with respect to the first surface. As a result, the design of the measurement arrangement is even flatter (in relation to the operating beam path for the first element). An even further simplified integration of the measurement arrangement into an existing measurement system or into an optical device is thus possible. Moreover, it is thus also possible, for example, to provide a plurality of measurement arrangements according to the invention, the light beams of which are coupled into the first element at different points and on different surfaces, such that the respective light beam sensor captures only the partial light beams from the light beam source assigned thereto and incorrect measurements are reliably avoided. The laterally arranged surface can be situated next to the surface as a continuation of the latter, or can be oriented at an angle of, for example, 30° to 120°, in particular 90°, with respect to the surface.

Preferably, the surface of the second element or of the EUV mirror is embodied to be non-spherical, in particular aspheric, or in the form of a free-form surface.

If the second element has at least one coating on the second surface, which coating brings about the effect that the partial light beam is reflected both at the surface of the coating and at an underlying boundary surface with the second optical element, two further partial light beams are produced from the partial light beam, which are reflected and coupled back into the first element and are guided through the latter to the light beam sensor. A second distance or the height of the coating is thus capturable. Here, the height of the coating is preferably used as a reference if the height of the coating is known in order to calibrate the light beam sensor for determining the distance of the elements relative to one another. Alternatively, a plurality of distances are captured by the light beam sensor, such as, for example, the distance of the first surface from the surface coating and from the distance of the boundary surface or from further boundary surfaces in the second element. Preferably, the at least one coating has a layer height of 10 nm to a few μm, such that the layer effect during the measurement is possibly low or can no longer be detected on account of measurement inaccuracies. Nevertheless, measurement data can be corrected on the basis of a known layer thickness. At least a correction of the centroid is possible with the advantageous measurement arrangement.

The distance measurement apparatus according to a second aspect of the invention is distinguished by at least one measurement arrangement according to the invention as has been described above. This results in the advantages already mentioned above. In particular, the distance measurement apparatus has a housing in which the light beam source and the light beam sensor and optionally the first lens element and the second lens element are arranged.

The distance measurement apparatus particularly preferably has two, three or six of the above-described measurement arrangement according to the invention, wherein the focus points of the light beams lie at a distance from one another on the first surface of the first optical element. As a result, distances are captured at different points between the two elements in order thus to determine the orientation of the elements with respect to one another. It is thus determined, in particular, through three measurement arrangements whether the two elements are arranged parallel to one another or in a desired orientation with respect to one another. In the case of strong free-form surfaces, preference is given to using six of the measurement arrangements. The measurement arrangements thus serve not only for capturing the distance but also for the orientation. The distance measurement apparatus preferably has a controller, which is designed to control the light beam source or light beam sources and to determine the captured distance or distances by evaluating the sensor signals of the light beam sensor or sensors.

The optical measurement system according to another aspect of the invention s distinguished by the distance measurement apparatus according to the invention. This results in the advantages already mentioned above. In particular, the measurement system has at least one actuator, which is designed and/or arranged to set or change a distance between the surfaces or between the optical elements and/or an orientation of the optical elements with respect to one another. In particular, the optical measurement system has at least one dedicated measurement light beam source and at least one dedicated measurement sensor for capturing a light beam generated by the measurement light beam source, with the light beam being reflected in particular at the test object to be measured, in particular in order to capture the shape or surface shape thereof. The path of this light beam is also referred to as the operating beam path of the measurement system. In other words, the measurement system has a separate measurement light beam source, and the distance measurement apparatus in turn has at least one dedicated separate (further) light beam source.

Particularly preferably, a beam path of the respective light beam of the at least one measurement arrangement differs from the operating beam path of the measurement system for surface shape measurement, for which purpose the input-coupling point of the light beam of the distance measurement apparatus into the first element and/or the output-coupling point/output-coupling points, in particular of the partial light beams, from the first element preferably lie outside the operating beam path. The beam path of the distance measurement apparatus thus lies at least partially, preferably completely, outside the operating beam path. As a result, it is ensured that the distance of the first optical element from the second optical element in a test installation, such as in particular in the optical measurement system from DE 10 2021 202 909 A1 already mentioned above, can be effected in situ, that is to say also during ongoing operation of the measurement system. More preferably, the input-coupling point and the output-coupling point/output-coupling points both lie outside the operating beam path. Alternatively or additionally, the light beam source and optionally also the first lens element, on the one hand, and/or the light beam sensor and optionally the second lens element, on the other hand, are preferably arranged outside the operating beam path of the measurement system with reference to at least one, preferably each, measurement arrangement of the distance measurement apparatus. In accordance with one embodiment, therefore, both the light beam source, the input-coupling point and the first lens element, and also the light beam sensor, the output-coupling point/output-coupling points and the second lens element lie outside the operating beam path, such that influencing of the measurement system when capturing the distance overall is avoided. According to an alternative embodiment, the input-coupling point or the output-coupling point/output-coupling points, or the input-coupling point and the output-coupling point/output-coupling points lie within the operating beam path. As a result, the light beam generated by the light beam source travels at least in sections through the operating beam path of the measurement system. Thereby, for example, a particularly space-saving variant of the measurement system is made possible.

The method according to a further aspect of the invention is distinguished by the fact that a light beam source is controlled such that a light beam is coupled into the first optical element through a surface that is different from the first surface of the first element, such that a first partial light beam is reflected by the first surface and a second partial light beam traveling through the first surface is reflected by the second surface in each case back into the first optical element, and wherein the two partial light beams are captured and the distance between the first and the second surface is ascertained depending on the captured partial light beams. This results in the advantages already mentioned.

Preferably, the light beam is focused with the aid of a first lens element such that a focus point of the light beam lies on the first surface. Furthermore, a second lens element is preferably arranged in the beam path between the first element and the light beam sensor and embodied such that the partial light beams are guided to the light beam sensor and in particular are focused in each case onto a sensor surface of the light beam sensor.

Further advantages and preferred features and combinations of features are evident in particular from the claims and from the above-description. Aspects of the invention will be explained in greater detail below with reference to the drawings.

### BRIEF DESCRIPTION OF THE DRAWINGS

In the drawings:

FIG. 1 shows an advantageous measurement arrangement according to a first exemplary embodiment,

FIGS. 2A and 2B show detail views from regions K1 and K2, respectively, of the measurement arrangement depicted in FIG. 1,

FIG. 3 shows an optical measurement system with advantageous measurement arrangements in a simplified illustration, and

FIG. 4 shows a flow chart for explaining a method for operating the measurement arrangements.

### DETAILED DESCRIPTION

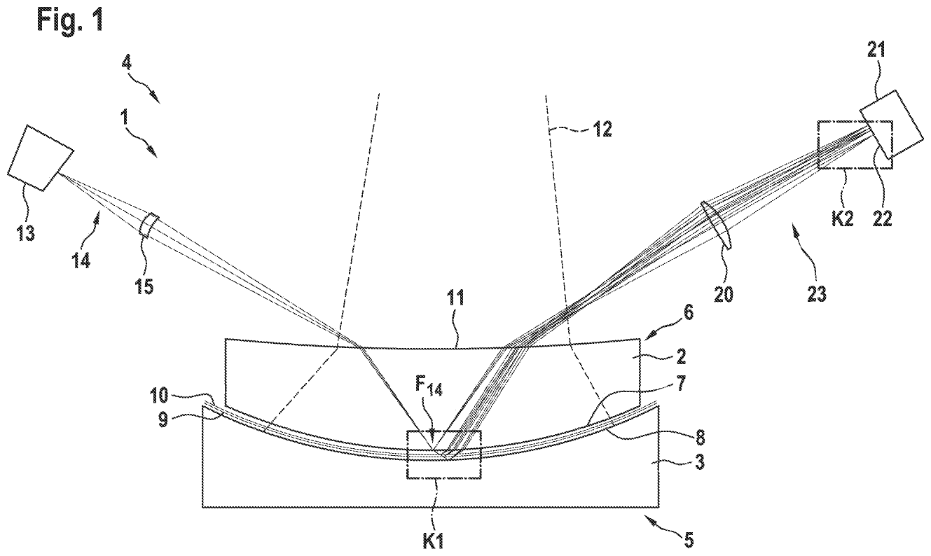

FIG. 1 shows, in a simplified side view, an advantageous measurement arrangement 1, which is designed to capture the distance between two optical elements 2, 3. In the present case, the optical elements 2, 3 are a test object 5 and a measurement matrix 6, wherein the measurement matrix 6 has a reference shape which serves for optically testing the surface shape of the test object 5 or of the element 3. Here, the first element 2 has a first surface 7, which lies at a distance opposite a second surface 8 of the second element 3.

The element 2 is thus a constituent part of an optical measurement system 4 (only partially illustrated here) or matrix measurement system, with which the test object can be examined. The measurement system 4 is in particular a measurement system for interferometric shape measurement of the test object 5. By way of example, such a measurement system 4 is described in patent application DE 10 2021 202 909 A1.

The test object 5 or the optical element 3 is a lithographic or microlithographic EUV mirror, for which purpose the surface 8 is embodied in particular to be non-spherical, in particular aspheric or in the form of a free-form surface, in order to reflect EUV radiation, in particular with a wavelength of less than 100 nm. The surface 8 is uncoated, coated and/or highly reflective. Optionally, the surface 8 has one or more coatings with which the reflection quality and quantity is improved.

In order to check the functioning of the mirror element, the surface 8 of the test object 5 facing the measurement matrix 6 is checked via the measurement system 4 to determine whether the surface 8 has a desired target shape.

As a result of the shape measurement, a deviation of the actual shape of the surface 8 from the target shape is determined. In this case, the target shape can be related to the reference shape or the surface 7. In particular, the target shape corresponds to the reference surface or the first surface 7, such that the surfaces 7, 8 are formed inversely with respect to one another or run parallel to one another. Alternatively, the target shape deviates from the reference surface.

For the measurement of the surface shape, for example, a laser beam is coupled into the element 2 through a further surface 11 facing away from the first surface 7, such that it travels through the element 2 and is partially reflected at the surface 8 such that a partial beam is reflected at the surface 7 and a partial beam is reflected at the surface 8. To this end, FIG. 1 shows, by way of example, an operating beam path 12 of the measurement system 4 with dashed lines. As a result of the interferometric evaluation of the reflected partial beams, the measurement signal supplies the distance between the surfaces 7 and 8.

Owing to the advantageous measurement arrangement 1, it is ensured that the distance between the elements 2 and 3 can also be ascertained in situ in the measurement system 4. This is advantageous in particular if, for example, the reference object, that is to say in this case the element 2, is mounted movably in order to carry out a test process. As a result of the movable mounting, precise arrangement of the element 2 with respect to the element 3 is necessary in order that the surfaces 7 and 8 lie opposite one another in a desired orientation and run parallel to one another, for example. In order to be able to set the orientation precisely and in order to prevent the element 2 from striking the element 3, the distance is advantageously captured and monitored with the measurement arrangement 1. The element 2 and the element 3 preferably each have a single spherical geometry.

For this purpose, the measurement arrangement 1 has a light beam source 13, in particular a light beam source 13 which is separate from the measurement system 4, which light beam source is designed to generate a light beam 14. For this purpose, the light beam source 13 is embodied, for example, in the form of an LED, fiber laser or laser device, or in the form of another light beam source for generating a structured light beam.

The light beam source 13 is assigned a first lens element 15, with which the generated light beam 14 is focused before it is incident on the first element 2. Here, the light beam source 13 and the lens element 15 are arranged and embodied such that the light beam 14 is coupled into the element 2 through the surface 11. In this case, the light beam source 13 and the lens element 15 are furthermore arranged and embodied such that the light beam 14 focused by the lens element 15 has its focus point F₁₄ on the surface 7 and is incident on the surface 7 at an angle deviating from 90° and thus obliquely. Moreover, the light beam 14 is coupled obliquely into the optical element 2 through the surface 11 such that the light beam 14 is aligned at an angle deviating from 90° to the surface at the input-coupling point.

The first lens element 15 is preferably embodied to correct or compensate for the effects of the refraction of the light beam 14 at the surface 11, with which the light beam 14 is coupled into the first element 2. In particular, the lens element 15 has a shape which is configured for this purpose. For this purpose, the lens element 15 preferably deviates from a rotationally symmetric lens element by more than 1 μm. Alternatively or additionally, the lens element 15 is preferably tilted for correction or compensation purposes about an axis aligned in particular perpendicular to the chief ray direction of the light beam or perpendicular to the drawing plane. Optionally, the lens element 15 is formed from a plurality of lens elements and/or mirrors, wherein at least one lens element of the lens element 15 deviates from the rotational symmetry by more than 1 μm.

Here, the light beam source 13 is arranged laterally of, in particular outside the operating beam path 12. In particular, the light beam source 13 is arranged laterally next to an axis which is aligned perpendicularly with respect to the surface 11 and which extends in particular through the input-coupling point. An angle between the light beam source 13, that is to say in particular the light beam, or beam, emitted by the light beam source 13, and the axis is smaller than 120°, preferably smaller than 90° and particularly preferably smaller than 45°.

Alternatively or additionally, the light beam source 13 can also be arranged such that the beam emitted by the light beam source 13 is incident on the surface 11 at an angle α, wherein the angle α is smaller than 75°, preferably smaller than 45° and particularly preferably smaller than 30°.

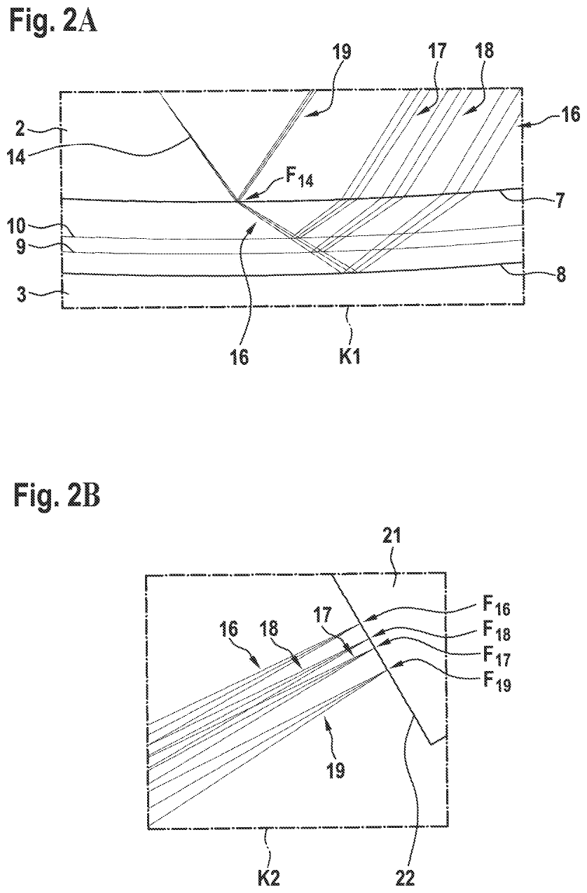

FIG. 2A shows a detail view of a region marked with a dashed box K1 in FIG. 1. In this region, the focus point F₁₄ of the light beam 14 lies on the first surface 7 of the element 2. The light wavelength of the light beam 14 preferably differs from the used wavelength of the measurement system by more than 10 nm. The surface 7 has a partially reflecting design, such that the light beam 14 is reflected at the surface 7 in a partial light beam 19 back in the direction of the surface 11. A further partial light beam 16 from the light beam 14 travels through the surface 7 and is incident on the surface 8 and is reflected by the latter back in the direction of the element 2, where the partial light beam 16 is coupled again into the element 2 through the surface 7 and directed to the surface 11, as shown in FIG. 1. Since the partial light beam 16 and also the partial light beam 19 fan out as a result of reflection, a plurality of fanned-out lines for the respective partial light beam 16, 19 are shown in FIGS. 1 to 2B.

FIGS. 1 to 3 show, by way of example, a plurality of distances of the elements 2 and 3 relative to one another, wherein the surface 8 of the second element 3 is provided with the reference sign 9 at a smaller distance from the surface 7 and with the reference sign 10 at an even smaller distance from the surface 7. Depending on the distance, the obliquely incident partial light beam 16 is reflected at different points. Thus, the partial light beam 16 is reflected as partial light beam 18 in accordance with the smaller distance through the surface 9, and the partial light beam 16 incident on the surface 10 is reflected as partial light beam 17. The partial light beams 17, 18 are also reflected back to the element 2, coupled in through the surface 7 and coupled out through the surface 11.

The measurement arrangement 1 furthermore has a second lens element 20 and a light beam sensor 21. The light beam sensor 21 has a sensor surface 22 which is embodied in a planar manner in particular and on which the partial light beam 19 and the respective partial light beam 16, 17 or 18 are directed through the lens element 20 such that in each case one focus point F₁₉ and F₁₆, F₁₇ or F₁₈ (depending on the present distance between the elements 2, 3) lies on the sensor surface 22. The light beam sensor 21 is, for example, a camera sensor, in particular a line scanner, wherein the sensor surface 22 is formed by the sensor.

In the present case, the lens element 15 forms a first focusing device, and the lens element 20 forms a second focusing device. Optionally, at least one of these focusing devices has at least one further optical element, such as in particular a lens element and/or a mirror, in order to advantageously focus the respective light beam or partial light beam.

By focusing the partial light beams onto the sensor surface 22, the position thereof on the sensor surface 22 is capturable by the camera sensor or the light beam sensor 21. In accordance with the present exemplary embodiment, the distance of the light beam source 13, the lens element 15, the lens element 20 and the light beam sensor 21 from the element 2 is always the same, or fixed. Only the element 3 is moved to a measurement position on the element 2.

FIG. 2B to this end shows a detail view according to the dashed box K2 from FIG. 1. The lens element 20 is embodied such to focus the partial light beams 16 to 19 that are coupled out of the surface 11 or the element 2 onto the sensor surface 22.

On account of the geometric circumstances and known materials and refractive indices associated therewith, the displacement or the distance of the focus points F₁₉ and F₁₆ from one another corresponds to the distance of the surfaces 7 and 8 from one another. Likewise, the displacement of the focus point F₁₉ to the focus point F₁₇ corresponds to the distance of the surface 7 from the surface 10 or to the smallest distance, shown in the present case, of the elements 2, 3 from one another. Accordingly, the distance of the focus point F₁₉ from the focus point F₁₈ corresponds to the distance of the surface 7 from the surface 9 or to the average distance shown.

Consequently, the distance both between surfaces 7, 8, that is to say between the reflective surfaces or boundary surfaces of the coatings 9 and 10, can be captured by with a measurement arrangement 1. Assuming that the coatings 9, 10 have a known thickness, the distances between the focus points F₁₇, F₁₆ and F₁₈ can be used as reference values for the calibration of the light beam sensor 21, in order to then ascertain the correct scale for assessing the distance of the surface 7 from the surface 8.

In particular, the lens elements 15 and 20 have an xy polynomial description on one side, that is to say are non-rotationally symmetric aspheres. As a result of the break in symmetry, the imaging aberration is advantageously corrected on account of the oblique input-coupling into the element 2.

Owing to the advantageous measurement arrangement 1, it is possible to achieve distance measurement accuracies of up to 1 μm in a measurement range of up to 10 mm. If the light beam sensor 21 is embodied in the form of a line camera, the measurement is carried out in a measurement time of less than 10 μs.

As a result of the advantageous embodiment of the measurement arrangement 1, the transmitter, that is to say the light beam source 13 and the first lens element 15, and also the receiver, that is to say the light beam sensor 21 and the second lens element 20, are arranged outside the operating beam path 12, in particular laterally with respect to an axis normal to the surface 7. Alternatively, however, it is also possible for exclusively the light beam source 13 and optionally the first lens element 15, or exclusively the receiver to be arranged outside the operating beam path 12, in particular laterally with respect to an axis normal to the surface 7. The transmitter and the receiver thus form, together with the optical element 2, an advantageous distance measurement apparatus 23. As a result, an advantageous integration of the measurement arrangement 1 or of the distance measurement apparatus into the measurement system 4 is provided, as a result of which an in-situ measurement of the distance is also ensured.

In accordance with the present exemplary embodiment, the light beams are coupled in and out here through the surface 11, which is formed on the side of the element 2 facing away from the surface 7. In this exemplary embodiment, the input-coupling and output-coupling points lie within the operating beam path 12. In accordance with a further exemplary embodiment, at least the input-coupling point or the output-coupling point lies outside the operating beam path 12. It is also possible for both the input-coupling point and the output-coupling points to be situated outside the operating beam path 12. Optionally, the surfaces 7 and 11 are provided in the region of the respective coupling point with a coating having a predetermined refractive index, with which input-coupling and output-coupling are improved.

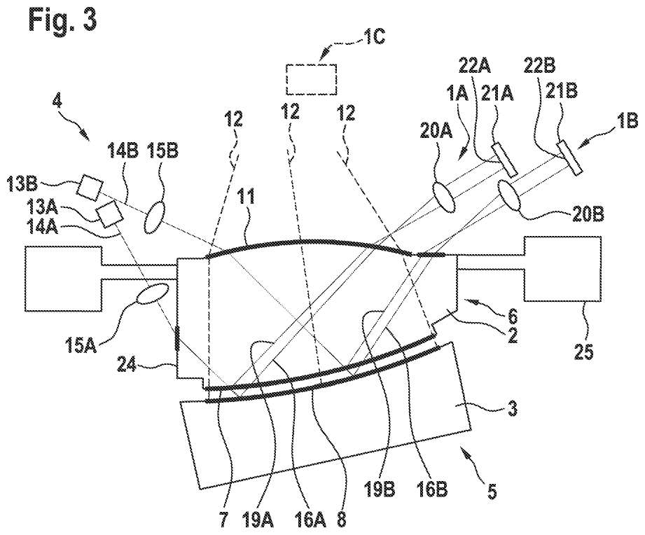

FIG. 3 shows a further exemplary embodiment of the measurement arrangement 1 in the measurement system 4. In this case, the distance measurement apparatus 23 has two of the measurement arrangements 1, namely a measurement arrangement 1A and a measurement arrangement 1B. The measurement arrangements 1A and 1B are embodied at least substantially in accordance with the measurement arrangement 1 of FIG. 1, with the differences which are explained below and which can be realized in each case alone or in combination also in the measurement arrangement in FIG. 1. Identical or analogous elements are provided with the same reference signs, wherein, in order to distinguish the measurement arrangements 1A and 1B from one another, an A or B is additionally assigned to the respective reference sign.

The measurement arrangement 1A differs from the measurement arrangement 1 in that the light beam source 13A and the lens element 15A are arranged and oriented such that the light beam 14A of the first measurement arrangement 1A is coupled into the element 2 not through the surface 11 but through a surface 24, or side face, arranged laterally with respect to the surface 7. The reflected partial beams 15A and 16A are coupled out of the surface 11 in the region of the operating beam path 12, so that they are incident, as described above, on the receiver composed of the lens element 20 and the light beam sensor 21, in particular line camera. As a result, the light beam 14A is coupled into the element 2 outside the operating beam 12 and is coupled out of it within the operating beam 12.

The measurement arrangement 1B differs from the measurement arrangement 1 in the present case in that the light beam 14B generated by the light beam source 13B is coupled into the element 2 through the surface 11 via the lens element 15 and is reflected at the surfaces 7, 8 as described above. In contrast to the previous exemplary embodiment, however, the reflected partial beams 19B and 16B are not coupled out of the element 2 in the region of the operating beam path 12, but in a section of the surface 11 that is spaced apart and adjacent thereto, and guided to the second lens element 20B and the second light beam sensor 21B. As a result, the light beam 14 is coupled into the element 2 within the operating beam 12 and is coupled out of it outside the operating beam 12. With the distance measurement apparatus 23, it is now possible to determine in a simple manner not only the distance, but also an orientation of the elements 2 and 3 with respect to one another in one measurement process.

The measurement apparatus preferably has at least one further measurement arrangement 1C, which is embodied in accordance with the measurement arrangement 1, 1A or 1B, or a combination thereof. The three measurement arrangements 1A, 1B and 1C are embodied such that they capture the distance between elements 2 and 3 or between surfaces 7 and 8 at three different points that do not lie in a line, so that the three-dimensional orientation of the elements 2, 3 with respect to one another is capturable.

Optionally, at least one of the measurement arrangements 1A, 1B and/or 1C, a plurality of the measurement arrangements 1A to 1C, or each of the measurement arrangements 1A to 1C is embodied such that the respective light beam is both coupled into the element 2 outside the operating beam path 12 and out of the element 2 outside the operating beam path 12. Thus, for example, the affected light beam is both input-coupled through a side wall spaced apart from the surface 11 and output-coupled from a side wall, in particular as partial beams, wherein the side walls are each oriented, laterally with respect to the surface 11, in particular at an angle of, for example, 45° to 90°. The measurement arrangements 1A to 1C can be embodied identically or differently with respect to the reference to the operating beam path 12.

Optionally, the measurement system 4 has a controllable actuator 25, with which the measurement matrix 6 or the element 2 is displaceable relative to the test object 5 or to the element 3, for example in order to adapt the orientation of the surfaces 7, 8 with respect to one another. Consequently, in combination with the measurement arrangements 1 and/or 1A, 1B and 1C or with the distance measurement apparatus 23, it is possible to ensure an orientation of the test object and the matrix with respect to one another without them striking one another by the actuator 25 being controlled depending on the measurement result.

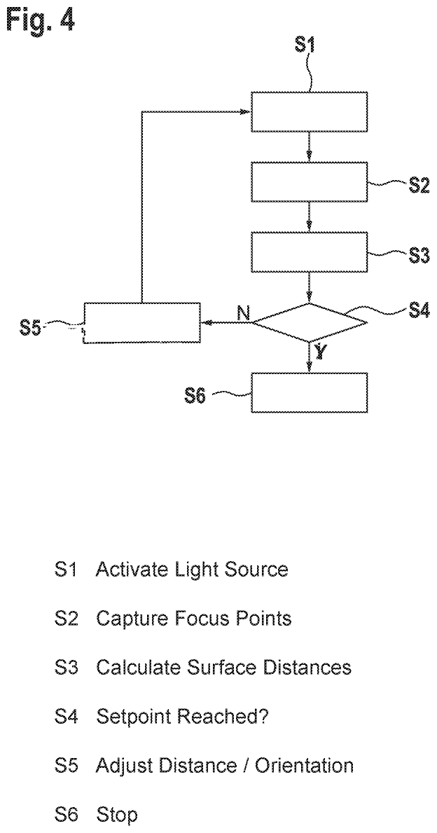

FIG. 4 to this end shows an advantageous operating method for operating the measurement system 4. In a first step S1, the measurement process is started and the respective light beam source 13 or 13A, 13B and/or 13C is activated. In the subsequent step S2, the focus points F₁₉ and—depending on the set distance—F₁₆, F₁₈ or F₁₇ are captured with the light beam sensors, in particular line cameras, and the distance thereof from one another on the respective sensor surface 22 or 22A, 22B, 22C is ascertained.

In the subsequent step S3, the distance of the surface 7 from the surface 8 at the reflection points is calculated on the basis of the captured distances of the focus points from one another, wherein the geometry and refractive indices of the distance measurement apparatus 23 are taken into account.

In the subsequent step S4, a check is carried out as to whether one or more of the captured distances falls below or exceeds a predefined limit value, and/or whether an orientation of the surface 7 with respect to the surface 8 corresponds to a target orientation. If this is not the case (N), the actuator 25 is controlled in a step S5 to change the orientation of the measurement matrix 6 for correcting the distances and/or the orientation. In this case, ascertaining the distance or distances ensures that the actuator is controlled such that the measurement matrix 6 does not strike the test object 5. As soon as the distance and/or the orientation correspond to the desired values (Y), the method is ended in step S6 and the measurement system 4 can begin with the actual shape measurement of the surface 8 of the test object 2.

In the case of spherical or approximately spherical surfaces, three measurement positions or three of the measurement arrangements are sufficient to avoid a collision of the elements 2, 3 with one another. The deviation from a sphere shape must be smaller than the smallest permitted distance. In the case of highly free-form surfaces, preferably 6 measurement arrangements or measurement positions are present in order to determine all six degrees of freedom (x, y, z displacements, and rotation about x, y, z axes), such that a collision is reliably avoided.

The above description of particular embodiments has been given by way of example. From the disclosure given, those skilled in the art will not only understand the present invention and its attendant advantages, but will also find apparent various changes and modifications to the structures and methods disclosed. The applicant seeks, therefore, to cover all such changes and modifications as fall within the spirit and scope of the invention, as defined by the appended claims, and equivalents thereof.

What is claimed is:

1. A measurement arrangement for determining at least one distance between a first optical element and a second optical element, wherein the first optical element is a light-transmissive measurement matrix and has a partially reflective first surface, wherein the second optical element is a mirror configured for extreme ultraviolet (EUV) radiation and has an at least partially reflective second surface, and wherein the first surface lies opposite the second surface at the distance to be determined, comprising:
a light beam source and a light beam sensor, wherein a light beam generated by the light beam source is coupled into the first optical element through a surface which differs from the first surface, such that a first partial light beam is reflected by the first surface and a second partial light beam traveling through the first surface is reflected by the second surface respectively back into the first optical element, and wherein the light beam sensor is arranged to capture both partial light beams in order to determine the distance dependent on the captured partial light beams.

2. The measurement arrangement as claimed in claim 1, further comprising a first focusing device, having at least one lens element and/or a mirror, arranged between the light beam source and the first optical element and is configured to focus the light beam at the first surface onto a first focus point.

3. The measurement arrangement as claimed in claim 2, wherein the light beam source and the lens element are arranged and configured such that the focused light beam is incident on the first surface at an angle deviating from 90°.

4. The measurement arrangement as claimed in claim 1, wherein the light beam source and the light beam sensor are arranged on a side of the first element facing away from the second element.

5. The measurement arrangement as claimed in claim 1, wherein the light beam source and the first focusing device are arranged and configured such that the light beam from the light beam source is coupled into the first optical element obliquely through the surface.

6. The measurement arrangement as claimed in claim 5, wherein the light beam is coupled into the first optical element at an angle is smaller than 75°.

7. The measurement arrangement as claimed in claim 1, further comprising at least one second focusing device with at least one lens element and/or at least one mirror arranged between the first element and the light beam sensor, with which second focusing device the partial light beams are directed onto the light beam sensor.

8. The measurement arrangement as claimed in claim 1, wherein at least one lens element of a first focusing device and/or a second focusing device is embodied in a non-rotationally symmetric manner.

9. The measurement arrangement as claimed in claim 7, wherein the lens element of the second focusing device is configured and arranged to focus the partial light beams onto the light beam sensor such that each partial light beam has a respective focus point which is capturable by the light beam sensor.

10. The measurement arrangement as claimed in claim 1, wherein the light beam sensor has a planar sensor surface, and wherein the at least one second lens element is configured and arranged to focus the partial light beams onto the sensor surface.

11. The measurement arrangement as claimed in claim 1, wherein the light beam source and the first lens element are arranged such that the generated light beam is coupled into the first element through a surface lying opposite the first surface.

12. The measurement arrangement as claimed in claim 2, wherein the light beam source and the lens element of the first focusing device are arranged such that the generated light beam is coupled into the first element through a surface of the first element arranged laterally with respect to the first surface.

13. The measurement arrangement as claimed in claim 1, wherein the surface of the second element is formed to be non-spherical or in the form of a free-form surface.

14. A distance measurement apparatus for capturing the distance between a first optical element and a second optical element, wherein the first optical element is configured to be light-transmissive and has a partially reflective first surface, wherein the second optical element has an at least partially reflective second surface, wherein the first surface lies opposite the second surface at the distance to be determined, comprising at least one measurement arrangement as claimed in claim 1.

15. The distance measurement apparatus as claimed in claim 14, further comprising at least one further measurement, wherein the focus points of the light beams lie at a distance from one another on the first surface of the first optical element.

16. An optical measurement system for checking the shape of an optical surface of a test object with an optical measurement matrix as a first optical element, wherein the test object as second optical element is arrangeable opposite the measurement matrix, wherein optionally a distance and/or an orientation of the first optical element with respect to the second optical element is variable through at least one actuator, comprising a distance measurement apparatus as claimed in claim 14.

17. The optical measurement system as claimed in claim 16, wherein a beam path of the respective light beam of the at least one measurement arrangement differs from an operating beam path of the measurement system for surface shape measurement.

18. The optical measurement system as claimed in claim 16, wherein the light beam source and the first lens element, and/or the light beam sensor and the second lens element of the at least one measurement arrangement of the distance measurement apparatus are arranged outside an operating beam path of the measurement system.

19. The optical measurement system as claimed in claim 16, wherein the light beam of the at least one measurement arrangement or at least one of the measurement arrangements is coupled into and/or coupled out of the first optical element outside the operating beam path of the measurement system.

20. The optical measurement system as claimed in claim 16, wherein the light beam of the at least one measurement arrangement or at least one of the measurement arrangements is coupled into and/or coupled out of the first optical element within the operating beam path of the measurement system.

21. A method for capturing a distance of a first optical element from a second optical element wherein the first element is embodied to be light-transmissive and has a partially reflective first surface, wherein the second optical element has an at least partially reflective second surface, and wherein the first surface lies opposite the second surface at the distance to be captured, comprising controlling a light beam source such that a light beam is coupled into the first optical element through a surface, which is different from the first surface of the first element, such that a first partial light beam is reflected by the first surface and a second, partial light beam traveling through the first surface is reflected by the second surface in each case back into the first optical element, capturing the two partial light beams, and ascertaining the distance between the first and the second surface depending on the captured partial light beams.
